(19) United States
(12) Patent Application Publication
(10) Pub. No.: US 2008/0040524 A1
(43) Pub. Date: Feb. 14, 2008

(54) System management mode using transactional memory

(76) Inventors: Vincent J. Zimmer, Federal Way, WA (US); Sham Datta, Hillsboro, OR (US); Michael A. Rothman, Puyallup, WA (US)

Correspondence Address: COURTNEY STANFORD & GREGORY LLP;C/O INTELLEVATE, P.O. BOX 52050, MINNEAPOLIS, MN, 55402, US

(21) Appl. No.: 11/503,689

(22) Filed: Aug. 14, 2006

(51) Int. Cl. G06F 13/24; G06F 13/32

(52) U.S. Cl. 710/267

(57) ABSTRACT

Embodiments of a system and method for servicing a hidden execution mode event in a multiprocessor computer system is described. A plurality of event handlers and shared memory resources are loaded or stored in a transactional memory space that is accessible to a hidden execution mode supported by each of a plurality of processors in the multiprocessor system. The event handlers are dispatched to different processors among the plurality of processors in response to the hidden execution mode event. A resource locking mechanism comprising a linked-list mechanism that stores entries consisting of work items to be executed by the processors, enables a specified resource of the one or more shared resources to be accessed by only one event handler at a time. The hidden execution mode event comprises a System Management Mode of a microprocessor, and the hidden execution mode event can be either a System Management Interrupt event or a Processor Management Interrupt event. The transactional memory can be either Hardware Transactional Memory or Software Transactional Memory.

### FIELD OF THE INVENTION

Embodiments are in the field of computer systems, and particularly in the field of concurrency methods for the system management mode of a microprocessor.

### BACKGROUND OF THE DISCLOSURE

Emergent microprocessor designs face critical scaling challenges, which has forced radical parallelism in design and deployment. To increase parallelism, certain microprocessors or Central Processing Units (CPUs) incorporate multiple processing cores per CPU socket. Present multi-core processors can incorporate from two to 32 separate cores per CPU, though greater numbers of processor cores per socket can also be integrated.

To further facilitate efficient processing, modem processors typically include special modes or execution environments to perform operating system (OS) independent functions, such as advanced power-management features and firmware tasks, such as BIOS (Basic Input/Output System) processes. One such mode is the System Management Mode (SMM), which was introduced on the Intel® 386SL (IA32) processor. SMM is a special-purpose operating mode provided for handling system-wide functions like power management, system hardware control, or proprietary OEM-designed code. This mode is effectively “hidden” because the operating system (OS) and software applications cannot see it or access it.

SMM-enabled processors typically enter the SMM mode through special interrupt signals. One such interrupt signal is a System Management Interrupt (SMI). A similar signal on another class of processors (such as the Intel® Itanium™) is a Processor Management Interrupt (PMI). For purposes of discussion, SMI and PMI signals are collectively referred to as xMI signals. The xMI interrupt signals are transmitted as broadcast signals to all of the processors in a system. In most present SMM designs, one processor runs the xMI handlers while the other processors wait. This “wait” activity is based upon the primitive software design in most conventional BIOS routines. Thus, when an xMI interrupt signal is received, all of the processors in a multi-core CPU are activated, and are not available for use by the general operating system.

Various methods may be implemented to minimize the downtime associated with servicing xMI interrupt signals by increasing the parallelism of the SMM threads. One such method involves threading the SMI handlers and distributing work across all available processors during the SMI and PMI activation periods to prevent having only one active and many waiting processors. However these methods generally rely on software routines, such as semaphores and the like, to mediate the common resource access requests.

Present methods of processing xMI signals in multi-core processing systems, thus, typically involve the use of software locks for mediation. These mechanisms can be prone to lock contention among parallel flows, which can negatively impact task dispatching. A further disadvantage associated with present is the use of atomic instructions (such as to acquire the lock, exchange instructions, time out and so on) that are generally inefficient when the number of processor is scaled up, since performing lock management in software is relatively slow.

### BRIEF DESCRIPTION OF THE DRAWINGS

FIG. 1 is a block diagram of an interface between operating systems and platform firmware that includes a transactional memory for a firmware execution regime.

FIG. 2 is a state diagram that illustrates the state and topology of a transactional memory that can be used for processing of SMM threads, under an embodiment.

FIG. 3 is a flow diagram that illustrates a method of processing a transaction state, under an embodiment.

FIG. 4 illustrates various functions and services provided by the SMM Nub of FIG. 1, under an embodiment.

FIG. 5 illustrates a multiprocessor computer system that can be used to implement one or more embodiments of using transactional memory for SMM operations.

### DETAILED DESCRIPTION

Embodiments described herein disclose the use of transactional memory for platform firmware execution regimes in multi-thread or multi-core processing systems. Systems and methods provide concurrent processing for the System Management Mode (SMM) of a multi-core microprocessor or highly parallel processing system using transactional memory (TM). Embodiments allow highly concurrent, contention-free execution of SMM code through the use of hardware and/or software transactional memory to allow multi-thread processing on shared data structures, memory locations, locks, and other shared data resources. The SMI occupancy time can be reduced by parallelizing the SMM flows and using hardware or software transactional memory structures to ensure that lock contention among the parallel flows do not impact task dispatching. Embodiments of the TM implemented SMM code mitigate lock-contention in highly parallel technologies to advantage a platform design with highly parallel firmware/SMM flows.

In one embodiment, executable content in the form of a plurality of software drivers or similar code are loaded into the System Management Mode (SMM) of an Intel® 32-bit family of microprocessor (i.e., IA-32 processors), or the native mode of an Itanium™-based processor with a PMI signal activation, and concurrently executed on multiprocessor computer systems that employ IA-32 and Itanium-based processors. SMM represents one type of execution environment for platform firmware, and other types of firmware execution regimes are also possible.

The state of execution of code in IA32 SMM is initiated by an SMI signal and that in Itanium processors is initiated by a PMI signal; for simplicity, these will generally be referred to as SMM. The mechanism allows for multiple drivers, possibly written by different parties, to be installed for SMM operation. An agent that registers the drivers runs in the EFI (Extensible Firmware Interface) boot-services mode (i.e., the mode prior to operating system launch) and is composed of a CPU-specific component that binds the drivers and a platform component that abstracts chipset control of the xMI (PMI or SMI) signals. The API's (application program interfaces),providing-these sets of functionality are referred to as the SMM Base and SMM Access Protocol, respectively.

In conventional SMM implementations, SMM space is often locked by the platform software/firmware/BIOS via hardware mechanisms before handing off control; this grants firmware the ability to abstract the control and security of this binding. In contrast, the software abstraction via the SMM Access protocol provided by embodiments of the disclosed system obviate the need of users of this facility to know and understand the exact hardware mechanism, thus allowing drivers to be portable across many platforms.

Embodiments of the concurrency mechanisms for SMM described herein include the following features: a library in SMM for the drivers' usage, including an I/O access abstraction and memory allocation services; a means to communicate with drivers and applications executing in non-SMM mode; an optional parameter for periodic activation at a given frequency; a means to authenticate the drivers on load into SMM; the ability to close the registration capability; the ability to run in a multi-processor environment where many processors receive the xMI activation. Embodiments further include a transactional memory for sharing stored resources and mediating shared resource accesses among different requesting processes or threads.

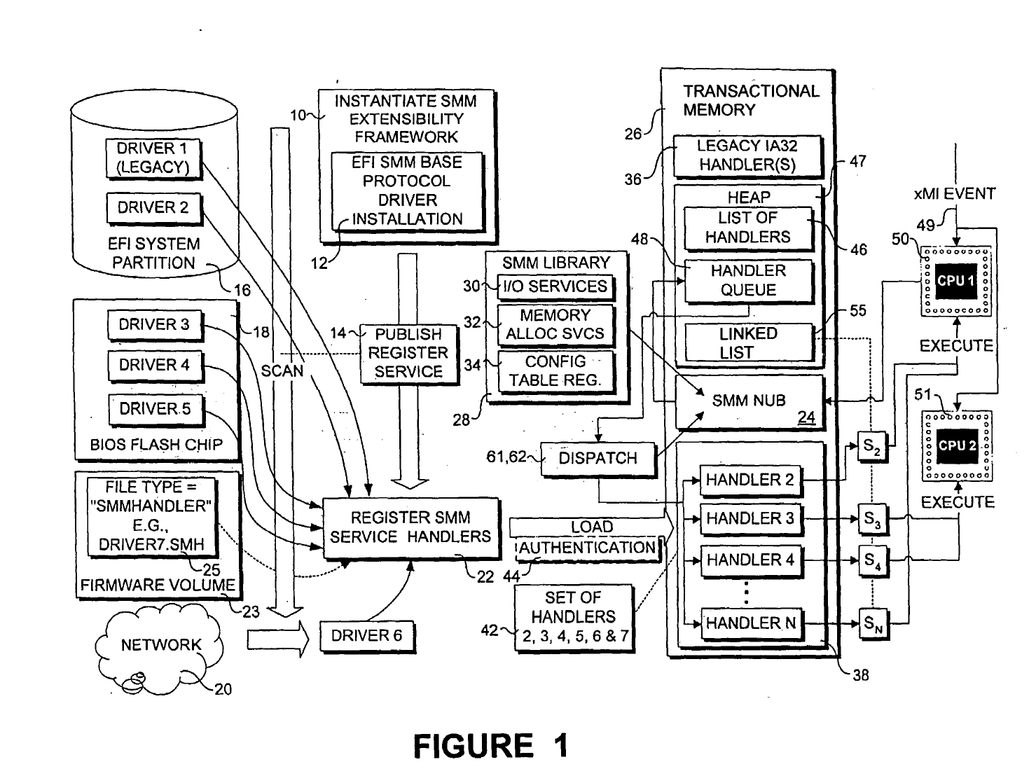

FIG. 1 is a block diagram of an interface between operating systems and platform firmware that includes a transactional memory for shared data resources. The interface consists of data tables that contain platform-related information, plus boot and runtime service calls that are available to the operating system and its loader. Together, these provide a standard environment for booting an operating system and running pre-boot applications. The process for producing the SMM extensibility framework is initiated in a block 10, wherein the SMM extensibility framework is instantiated. This includes installing an EFI SMM base protocol driver in a block 12. The EFI SMM base protocol, SMM_BASE, is a CPU-specific protocol that is published by the CPU driver or another agency that can abstract the ISA-specific details of an IA32 or Itanium processor. Once installed, SMM_BASE publishes an SMM handler register service in a block 14. Publication of the handler register service enables legacy and add-on drivers that are stored on various storage devices, including an EFI system partition 16, a BIOS flash chip 18 and on a storage device accessed via a network 20 to register SMM event handlers in a block 22. In addition to these types of storage devices, the drivers may be stored on other persistent storage devices that are accessible to the computer system in which the embodiments are implemented, including motherboard-based ROMs (read-only memories), option-ROMs contained on add-on peripheral cards, local hard disks and CD-ROMs (Compact Disk ROMs), which are collectively depicted by a firmware volume 23. It should be noted that EFI system partition 16, BIOS flash chip 18 and the remote storage device on which driver 6 resides also may comprise firmware volumes. As depicted in FIG. 1, these drivers include a legacy driver 1 and an add-on driver 2 stored in EFI system partition 16, add-on drivers 3, 4, and 5, which are stored on BIOS flash chip 18, and an add-on driver 6 that is accessed from a remote storage device (e.g., file server) via network 20. As used herein, the term “add-on” corresponds to drivers and firmware files that were not provided with the original firmware of the computer system as provided by the original equipment manufacture (OEM) of that system.

In an optional mode, the EFI SMM base protocol driver may scan various firmware volumes to identify any drivers that are designated for servicing xMI events via SMM. In one embodiment, these drivers are identified by their file type, such as exemplified by a “DRIVER7.SMH” file 25 corresponding to an add-on driver 7. During the installation of the EFI SMM base protocol driver, an SMM Nub 24 is loaded into transactional memory (TM) 26, which can comprise an SMM-only memory space. The SMM Nub 24 is responsible for coordinating all activities while control is transferred to SMM, including providing an SMM library 28 to event handlers that includes PCI and I/O services 30, memory allocation services 32, and configuration table registration 34.

Registration of an SMM event handler is the first operation in enabling the handler to perform a particular xMI event servicing function it is designed to perform. An SMM event handler comprises a set of code (i.e., coded machine instructions) that when executed by a system processor (CPU) performs an event service function in a manner similar to an interrupt service routine. Typically, each SMM event handler will contain code to service a particular hardware component or subsystem, or a particular class of hardware. For example, SMM event handlers may be provided for servicing errors caused by the system's real time clock, I/O port errors, PCI device errors, etc. In general, there may be some correspondence between a given driver and an SMM event handler. However, this is not a strict requirement, as the handlers may comprise a set of functional blocks extracted from a single driver file or object.

When the event handler for legacy driver 1 is registered, it is loaded into TM 26 as a legacy handler 36. A legacy handler is an event handler that is generally provided with the original system firmware and represents the conventional mechanism for handling an xMI event. As each add-on SMM event handler is registered in block 22, it is loaded into an add-on SMM event handler portion 38 of TM 26; once all of add-on event handlers are loaded, add-on SMM event handler portion 28 comprises a set of event handlers corresponding to add-on drivers 2-7, as depicted by a block 42. In addition, as each SMM event handler is registered, it may optionally be authenticated in a block 44 to ensure that the event handler is valid for use with the particular processor and/or firmware for the computer system. For example, an encryption method that implements a digital signature and public key may be used. As SMM event handlers are registered, they are added to a list of handlers 46 stored in a heap 47 maintained by SMM Nub 24.

Once all of the legacy and add-on SMM event handlers have been registered and loaded into TM 26 and proper configuration data (metadata) is written to SMM Nub 24, the TM is locked, precluding registration of additional SMM event handlers. The list of handlers is also copied to a handler queue 48, which may be stored in heap 47 and accessed by SMM Nub 24 or stored directly in SMM Nub 24. The system is now ready to handle various xMI events via SMM.

As shown in FIG. 1, common resources, such as the legacy handlers 36, the heap 47, the SMM NUB 24 and the handlers 38 are stored in transactional memory 26. In general, Transactional Memory (TM) is a concurrency control mechanism that is analogous to database transactions for controlling access to shared memory in concurrent computing. In one embodiment, the TM is implemented as Hardware Transactional Memory (HTM). Alternatively, the TM can be implemented as software transactional memory (STM). In general, software TM emulates HTM by providing a library that allows the processes to acquire a lock, and the management of rollback and pending operations is performed in software.

Transactional Memory systems offer an alternative method to lock-based synchronization, and are typically implemented to be lock-free. Transactions are executed as a series of reads and writes to shared memory, which logically occur at a single instant in time. Using TM, every thread completes its modifications to shared memory without regard to the activities of other threads, and read/write operations are recorded in a log. Changes to shared memory for an entire transaction are validated and committed if other threads have not concurrently made changes. A transaction may be aborted, which causes all of its prior changes to be rolled back (undone). If a transaction cannot be committed due to conflicting changes, it is typically aborted and re-executed from the beginning until it succeeds. In general, when using TM, no thread needs to wait for access to a resource, and different threads can simultaneously modify different parts of a data structure that would be protected under the same lock. Through the use of the transactional memory, the SMI occupancy time can be reduced by parallelizing the SMM flows and using the transaction memory to ensure that lock contention among the parallel flows do not impact task dispatching. TM generally features the ability to be implemented on top of cache-coherence protocols and provides transactions with the properties of atomicity (all-or-nothing) and serializability (one-at-a-time order).

In one embodiment, the use of TM mechanisms can be implemented using one or more instructions defined by the compiler. The following code segment illustrates sample code that can implement an HTM-based access, according to an embodiment.

```
EFI_STATUS
EfiAcquireLockOrFail (
  IN EFI_LOCK  *Lock
  )
  // MP-ready case.  Use HTM
{
  Begin_xaction [memory region designated by “Lock”]
}
VOID
EfiReleaseLock (
  IN EFI_LOCK  *Lock
  )
  // MP-ready case.  Use HTM
{
  End_xaction [memory region designated by “Lock”]
      }
```

One potential problem with the multi-processor configuration of FIG. 1 is the case in which the first processor submits a request at about the same time as the second processor and the data written to the common resource (e.g., an I/O port) pertained to the wrong request. In order to prevent this, the transactional memory includes a linked list structure 55 to ensure that a given resource or set of resources (e.g., I/O port or set of I/O ports, memory ranges, etc.) can only be accessed by only one event handler at a time.

Unlike software locking schemes that involves the storage of semaphore data and software exchanges to set/reset the semaphore, the linked list mechanism 55 within the transactional memory 26 allows access to shared resources in an automatically sequential manner that is analogous to hardware buffer accesses. If multiple processes try to access the same resource, access is granted to the first process, and the other processes retry using standard memory access cycles. This mechanism potentially saves a great deal of time over software locking methods, which require a delay until the semaphore corresponding to the accessed resources are cleared.

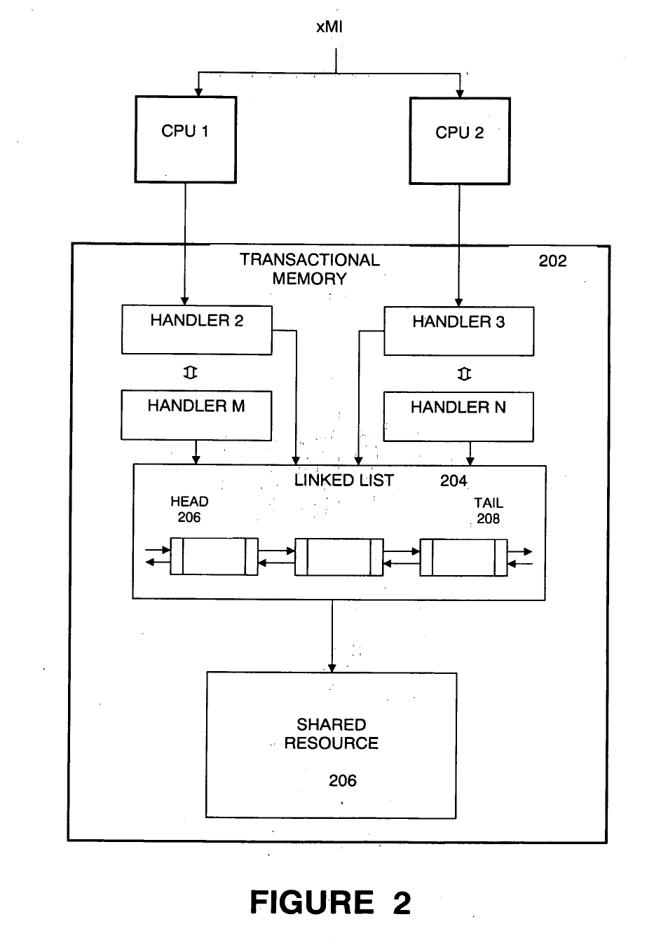

FIG. 2 is a state diagram that illustrates the state and topology of a transactional memory that can be used for processing of SMM threads, under an embodiment. FIG. 2 generally illustrates the handling of an xMI event in accordance with a transactional memory access method, under an embodiment. In response to an xMI event, operations are performed using CPU's 1 and 2. The dispatching of handlers then begins, wherein handler 2 through M are dispatched to CPU 1 and handlers 3 through N are dispatched to CPU 2. The handlers access or make a call to the appropriate shared resource 206. If two or more handlers make a simultaneous request to the same resource, the transactional memory structure 202 containing linked list 204 mediates the requests and grants access to the first requesting handler. Upon completion of the first handler, a second handler is granted access to the resource after waiting for the resource to become available. In one embodiment, pending handlers can be ordered in a handler queue. Alternatively, each waiting handler can periodically retry access to the shared resource. Eventually, a last handler is dispatched, and upon completion of execution, the processors are restored to their prior machine state and execution modes.

In one embodiment, the transactional memory 202 is implemented as shared system memory that accessed through Application Program Interfaces (APIs) by the processors (e.g., CPUs 1 and 2). There can be various different access methods corresponding to different APIs. One such method is a Load-Transactional (LT) method in which the value of a shared memory location is read into a register. A second method is a Load-Transactional-Exclusive (LTX) method in which the value is read into a register, and there is an indication that the location read is likely to be updated soon. A third method is a Store-Transactional method (ST) in which a value is tentatively written from a register to a shared memory location, and this value becomes visible to the other processors only when the transaction successfully commits.

Different APIs can also be used to manipulate a transaction state. A transaction, T, is successfully committed only if there are no memory-access conflicts. That is, no other transaction has written locations read or written by T, and no other transaction has read locations written by the T. An abort transaction causes all transaction updates to be discarded. A validate transaction returns the current status of T (i.e., whether T has aborted or not), and discontinues the transaction after it aborts.

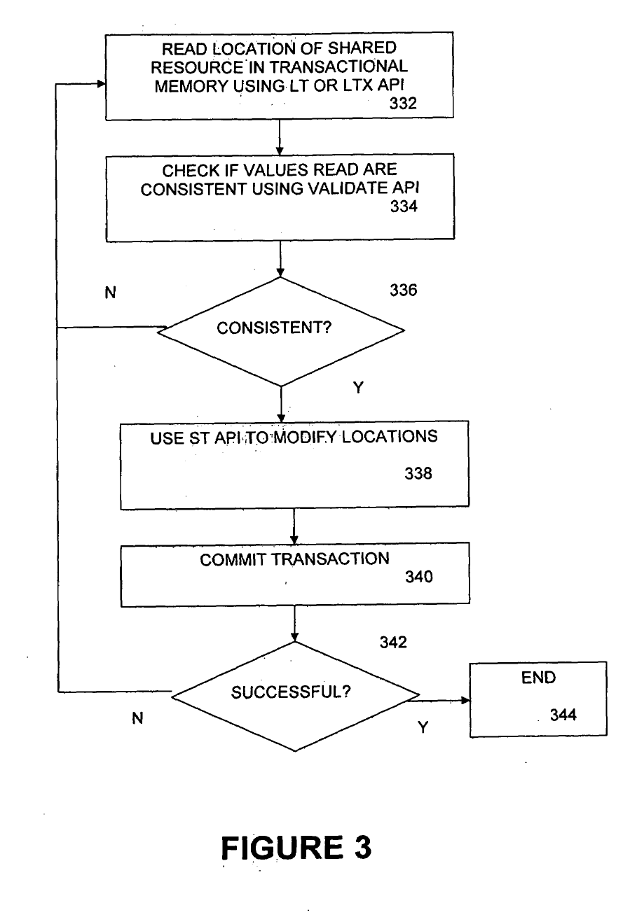

As described in embodiments shown herein, the transactional memory mechanism moves critical section management from software to the hardware or data structure. The composing of critical sections on each CPU does not require orchestration by software, but is instead managed by an STM algorithm or the cache/virtual memory subsystem of the HTM. FIG. 3 is a flow diagram that illustrates a method of processing a transaction state, under an embodiment. In block 332, the process starts by reading a location of a shared resource in transactional memory using the LT or LTX API. The values that are read are then checked for consistency using the Validate transaction operation, block 334. If it is determined that they are not consistent, in block 336, the process loops back to the read of another or the same location. If they are consistent, the ST API is used to modify the locations, block 338. The transaction is then committed, as shown in block 340. If the commit transaction is successful, as determined in block 342, the process ends, otherwise processing resumes from the read of another or the same location, block 332.

As shown in FIG. 2, the linked list structure 204 comprises a number of doubly-linked list entries. Each entry comprises a work item that is to be performed by a processor. The linked list can also include a pointer to one or more of the processors in the system. The linked list 204 comprises a head 206 and a tail 208. There are two basic linked-list operations, an enqueue operation that puts an item onto the list at the tail 208, and a dequeue operation that removes the item pointed to by the head 206. The enqueue and dequeue operations can be concurrent when the list is not empty, and implementation of the linked-list in transactional memory allows concurrent atomic accesses to the head and the tail. Each item in the linked list generates an event log, and causes an access to hardware or a shared resource in response to the event. The access request is manifested as an xMI signal that generates a handler that attempts to access the shared resource, as shown in FIG. 2 The following code segment illustrates sample code that can implement a doubly-linked list utilizing the APIs described above.

```
Shared entry *Head, *Tail;
Void list_eng(entry *new) {
    Entry *old_tail;
    New -> next = new ->prev = NULL;
    While (1)
    {
      old_tail = (entry*)LTX (&Tail);
      if (VALIDATE( )) {
        st(&new->prev, old_tail);
      if (old_tail = = NULL) { // empty list
        ST(&Head, new);
      } else { // non-empty list
          ST(&old_tail ->next, new);
      }
      ST(&Tail, new);
      If (COMMIT( )) return;
    }
    Wait_sometime( );
  }
}
```

In one embodiment, the system includes a transactional cache to hold the transactional data. For this, each transactional operation (i.e., LT, LTX, ST) caches two copies of the line in the transactional cache. A “committed” copy contains the last committed data, and a “tentative” copy contains the data modified by the transaction. An abort discards all tentative copies, and a commit marks all tentative copies as the latest committed copies. The system also implements a cache coherency protocol to allow two types of access rights, exclusive and non-exclusive, to a location (shared resource). In a read-write conflict, before a processor P can read from a shared location L, it must acquire non-exclusive access to L. Before a second processor Q can write to L, it must acquire exclusive access to L. In a read-write conflict, the process aborts either the first processor's or second processor's transaction. Interrupt signals and overflow conditions can also abort the current transaction.

Request to the shared resources are performed by handlers that translate xMI requests from system firmware/BIOS elements, such as sensors (e.g., temperature, voltage, etc.), hardware components (I/O ports, etc.), processes (e.g., power-up, etc.), and so on, into corresponding requests for access to shared resources. As shown in FIG. 1, heap 47 will typically comprise a reserved portion of TM 26. As discussed above, it will include data pertaining to a list of handlers 46, and handler queue 48, and the linked list 55. In the one embodiment, the list of handlers includes a handler identifier that is used to identifying each handler and a corresponding starting address that provides for the first instruction of the code for that handler. The handler queue comprises a table that includes the handler identifier, a handler status, and a CPU identifier that identifies what CPU the handler is executing or was executed on.

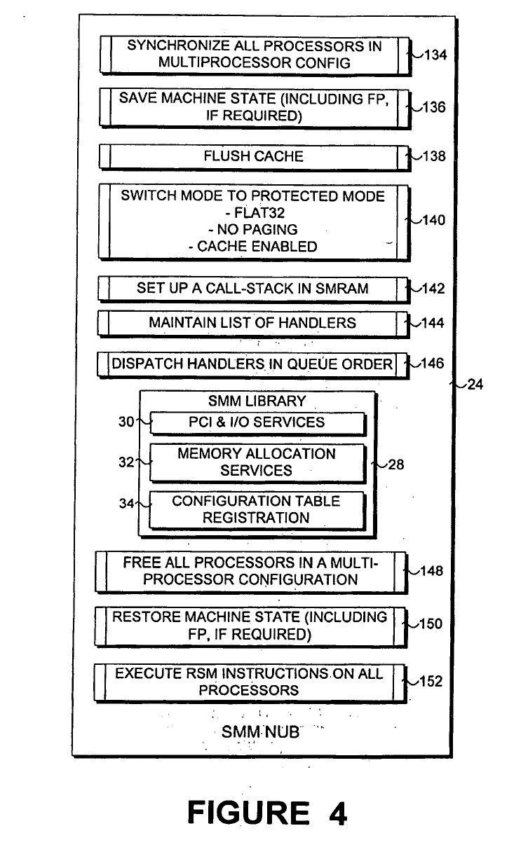

As discussed above, SMM Nub 24 is responsible for coordinating activities while the processors are operating in SMM. The various functions and services provided by one embodiment of SMM Nub 24 are graphically depicted in FIG. 4. These functions and services include synchronizing all of the processors for multiprocessor configurations, saving the machine state, including floating point registers, if required, and flushing the cache, as provided by function blocks 134, 136, and 138. The SMM Nub also provides a mode switching function 140 that switches the processor mode from real mode to protected mode, as discussed above with reference to block 130. The mode switching function 140 also enables the processor's internal cache. Other functions provided by SMM Nub 24 include setting up a call-stack in TM 26, maintaining list of handlers 46, and maintaining handler queue 48, as depicted by function blocks 142, 144, and 146.

SMM Nub 24 provides a set of services to the various event handlers through SMM library 28, including PCI and I/O services 30, memory allocation services 32, and configuration table registration services 34. In addition, SMM Nub 24 provides several functions that are performed after the xMI event is serviced. If the computer system implements a multiprocessor configuration, these processors are freed by a function 148. A function 150 restores the machine state of the processor(s), including floating point registers, if required. Finally, a function 152 is used to execute RMS instructions on all of the processors in a system.

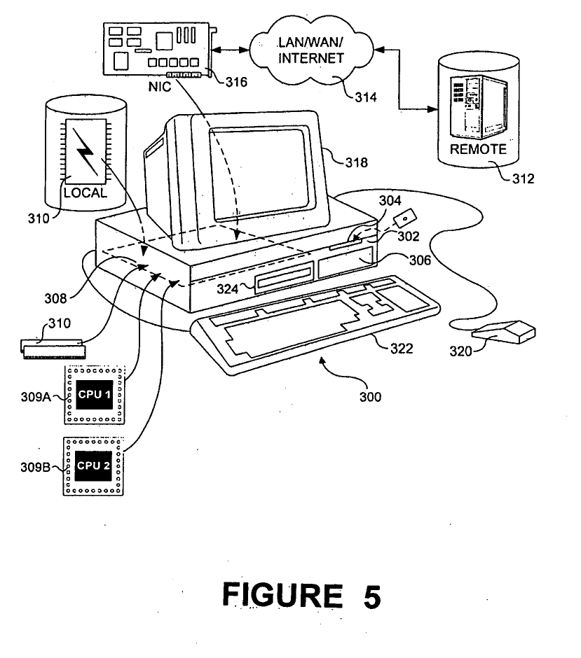

FIG. 5 illustrates a multiprocessor computer system that can be used to implement one or more embodiments of using transactional memory for SMM operations. Multiprocessor computer system 300 includes a processor chassis 302 in which are mounted a floppy disk drive 304, a hard drive 306, a motherboard 308 populated with appropriate integrated circuits including a plurality of processors (depicted as processors 309A and 309B), one or more memory modules 310, and a power supply (not shown), as are generally well known to those of ordinary skill in the art. Motherboard 308 also includes a local firmware storage device 311 (e.g., flash EPROM—Eraseable Programmable Read-Only Memory) on which the base portion of the BIOS firmware is stored. To facilitate access to the portion of the BIOS firmware that is retrieved from a remote firmware storage device 312 via a network 314, personal computer 300 includes a network interface card 316 or equivalent circuitry built into motherboard 308. Network 314 may comprise a LAN, WAN, and/or the Internet, and may provide a wired or wireless connection between personal computer 300 and remote firmware storage device 312.

A monitor 318 is included for displaying graphics and text generated by software programs that are run by the personal computer and which may generally be displayed during the POST (Power-On Self Test) and other aspect of firmware load/execution. A mouse 320 (or other pointing device) is connected to a serial port (or to a bus port) on the rear of processor chassis 302, and signals from mouse 320 are conveyed to motherboard 308 to control a cursor on the display and to select text, menu options, and graphic components displayed on monitor 318 by software programs executing on the personal computer. In addition, a keyboard 322 is coupled to the motherboard for user entry of text and commands that affect the running of software programs executing on the personal computer.

Personal computer 300 also optionally includes a compact disk-read only memory (CD-ROM) drive 324 into which a CD-ROM disk may be inserted so that executable files and data on the disk can be read for transfer into the memory and/or into storage on hard drive 306 of personal computer 300. If the base BIOS firmware is stored on a re-writeable device, such as a flash EPROM, machine instructions for updating the base portion of the BIOS firmware may be stored on a CD-ROM disk or a floppy disk and read and processed by the computer's processor to rewrite the BIOS firmware stored on the flash EPROM. Updateable BIOS firmware may also be loaded via network 314.

Although the present embodiments have been described in connection with a preferred form of practicing them and modifications thereto, those of ordinary skill in the art will understand that many other modifications can be made within the scope of the claims that follow. Accordingly, it is not intended that the scope of the described embodiments in any way be limited by the above description, but instead be determined entirely by reference to the claims that follow.

For example, embodiments can be implemented for use on a variety of different multiprocessing systems using different types of CPUs, such as Itanium Processors, and so on. Furthermore, although embodiments have been described for the use of transactional memory with SMM code, it should be understood that aspects can cover the use of transactional memory with any type of execution environment for platform firmware, and can cover any runtime modes, such as 16-bit, 32-bit, 64-bit, 128-bit, or more. Embodiments could also be directed to use as a multiprocessor driver, that is, for general boot-time, pre-OS, firmware flows.

For the purposes of the present description, the term “processor” or “CPU” refers to any machine that is capable of executing a sequence of instructions and should be taken to include, but not be limited to, general purpose microprocessors, special purpose microprocessors, application specific integrated circuits (ASICs), multi-media controllers, digital signal processors, and micro-controllers, etc.

The memory associated with system 100, including TM 26, may be embodied in a variety of different types of memory devices adapted to store digital information, such as static random access memory (SRAM), dynamic random access memory (DRAM), synchronous dynamic random access memory (SDRAM), and/or double data rate (DDR) SDRAM or DRAM, and also non-volatile memory such as read-only memory (ROM). Moreover, the memory devices may further include other storage devices such as hard disk drives, floppy disk drives, optical disk drives, etc., and appropriate interfaces. The system may include suitable interfaces to interface with I/O devices such as disk drives, monitors, keypads, a modem, a printer, or any other type of suitable I/O devices.

Aspects of the methods and systems described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Implementations may also include microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

While the term “component” is generally used herein, it is understood that “component” includes circuitry, components, modules, and/or any combination of circuitry, components, and/or modules as the terms are known in the art.

The various components and/or functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list; all of the items in the list; and any combination of the items in the list.

The above description of illustrated embodiments is not intended to be exhaustive or limited by the disclosure. While specific embodiments of, and examples for, the systems and methods are described herein for illustrative purposes, various equivalent modifications are possible, as those skilled in the relevant art will recognize. The teachings provided herein may be applied to other systems and methods, and not only for the systems and methods described above. The elements and acts of the various embodiments described above may be combined to provide further embodiments. These and other changes may be made to methods and systems in light of the above detailed description.

In general, in the following claims, the terms used should not be construed to be limited to the specific embodiments disclosed in the specification and the claims, but should be construed to include all systems and methods that operate under the claims. Accordingly, the method and systems are not limited by the disclosure, but instead the scope is to be determined entirely by the claims. While certain aspects are presented below in certain claim forms, the inventors contemplate the various aspects in any number of claim forms. Accordingly, the inventors reserve the right to add additional claims after filing the application to pursue such additional claim forms for other aspects as well.

What is claimed is:

1. A method of servicing a hidden execution mode event in a multiprocessor computer system, comprising:
loading a plurality of event handlers into a transactional memory space that is accessible to a hidden execution mode supported by each of a plurality of processors in the multiprocessor system;
dispatching event handlers from among the plurality of event handlers to different processors from among the plurality of processors in response to the hidden execution mode event;
storing one or more shared resources in the transactional memory; and
providing a resource locking mechanism that enables a specified resource of the one or more shared resources to be accessed by only one event handler at a time.

2. The method of claim 1, wherein the hidden execution mode event comprises a System Management Mode of a microprocessor, and the hidden execution mode event comprises a System Management Interrupt event.

3. The method of claim 1, wherein the hidden execution mode event comprises a Processor Management Interrupt event.

4. The method of claim 1, wherein the transactional memory is hardware transactional memory.

5. The method of claim 1, wherein the transactional memory is software transactional memory.

6. The method of claim 1, wherein the resource locking mechanism comprises a doubly-linked list containing a list of work items to be performed by a processor of the plurality of processors.

7. The method of claim 6, wherein doubly-linked list includes a pointer to a processor.

8. The method of claim 7, wherein the resource locking mechanism allows access to the specified resource by the first processor that requests access, and forces a second requesting processor to retry access until the first processor completes execution of a work item contained in the doubly-linked list.

9. The method of claim 8 wherein the specified resource is selected from the group consisting of a memory location, a register, and an input/output port.

10. An apparatus comprising:
a plurality of processors;
one or more hardware resources used by a processor of the plurality of processors to perform a task;
a transactional memory coupled to the plurality of processors, the transactional memory containing a plurality of event handlers that are accessible to a hidden execution mode supported by each of the plurality of processors;
a dispatch circuit coupled to the transactional memory to dispatch event handlers from among the plurality of event handlers to different processors from among the plurality of processors in response to the hidden execution mode event; and
a resource locking mechanism to enable a specified resource of the one or more shared resources to be accessed by only one event handler at a time.

11. The apparatus of claim 10, wherein the hidden execution mode event comprises a System Management Mode of a microprocessor, and the hidden execution mode event is selected from the group consisting of a System Management Interrupt event, and a Processor Management Interrupt event.

12. The apparatus of claim 10, wherein the transactional memory is selected from the group consisting of hardware transactional memory, and software transactional memory.

13. The apparatus of claim 10, wherein the resource locking mechanism comprises a doubly-linked list containing a list of work items to be performed by a processor of the plurality of processors.

14. The apparatus of claim 10, wherein the resource locking mechanism allows access to the specified resource by the first processor that requests access, and forces a second requesting processor to retry access until the first processor completes execution of a work item contained in the doubly-linked list.

15. The apparatus of claim 14, wherein the resource locking mechanism comprises software code generated by a compiler that translates high level code to a code body that is executable by a processor of the plurality of processors.

16. A machine-readable medium having a plurality of instructions stored thereon that, when executed by a processor in a system, performs the operations of:
loading a plurality of event handlers into a transactional memory space that is accessible to a hidden execution mode supported by each of a plurality of processors in the multiprocessor system;
dispatching event handlers from among the plurality of event handlers to different processors from among the plurality of processors in response to the hidden execution mode event;
storing one or more shared resources in the transactional memory; and
providing a resource locking mechanism that enables a specified resource of the one or more shared resources to be accessed by only one event handler at a time.

17. The machine-readable medium of claim 16, wherein the hidden execution mode event comprises a System Management Mode of a microprocessor, and the hidden execution mode event is selected from the group consisting of a System Management Interrupt event, and a Processor Management Interrupt event.

18. The machine-readable medium of claim 17, wherein the transactional memory is selected from the group consisting of hardware transactional memory, and software transactional memory.

19. The machine-readable medium of claim 18, wherein the resource locking mechanism comprises a doubly-linked list containing a list of work items to be performed by a processor of the plurality of processors.

20. The machine-readable medium of claim 10, wherein doubly-linked list includes a pointer to a processor, and wherein the resource locking mechanism allows access to the specified resource by the first processor that requests access, and forces a second requesting processor to retry access until the first processor completes execution of a work item contained in the doubly-linked list.

21. The machine-readable medium of claim 18, wherein the instructions are generated by a compiler that translates high level code to a code body that is executable by the processor.
